(19) United States
(12) Patent Application Publication
(10) Pub. No.: US 2007/0206248 A1
(43) Pub. Date: Sep. 6, 2007

(54) Biometric Hologram Based Data Verification Methods And Apparatus

(76) Inventors: David Roy Winterbottom, Essex (GB); John David Wiltshire, Essex (GB); Ben Bowmaker, Suffolk (GB)

Correspondence Address: Christopher P Harris;Tarolli Sundheim Covell & Tummino, Suite 1700, 1300 East Ninth Street, Cleveland, OH, 44114, US

(21) Appl. No.: 10/574,205

(22) PCT Filed: Oct. 1, 2004
(86) PCT No.: PCT/GB04/50014

§ 371 Date: Apr. 25, 2007

(30) Foreign Application Priority Data
Oct. 1, 2003 (GB) 0322978.8

(51) Int. Cl. G03H 1/00

(52) U.S. Cl. 359/2

(57) ABSTRACT

This invention generally relates to methods and apparatus for verifying data, and more particularly to holographic data carriers and apparatus for creating such data carriers, and to methods of verifying data stored on holographic data carriers. A data carrier comprising: a hologram storing data to reproduce an image of a portion of a human body characteristic of an individual; and a second data bearing device; and wherein data stored by said second data bearing device is verifiable using data stored in said hologram.

This invention generally relates to methods and apparatus for verifying data, and more particularly to holographic data carriers and apparatus for creating such data carriers, and to methods of verifying data stored on holographic data carriers and to methods of using holographic data to verify other data systems.

Holograms are well known as security devices and biometric technologies are useful in verifying personal identity. Here a biometric comprises a human characteristic useful for identifying an individual, such as a fingerprint, face, iris or retina image, a voiceprint, and, of a more abstract nature, a pattern of finger lengths. It is noted that both a voiceprint and abstract characteristics such as finger patterns may be represented as an image.

Identity fraud (the use of a fraudulent identity) takes place in the context of drug running, money laundering, terrorism, fraudulent claiming, illegal immigration and, on a more personal level, credit card crime. The cost of such fraud is extremely high and standards are developing for machine-readable documents including a facial image and a contact-less integrated circuit chip encrypted using public key infrastructure technology. The chip may store images of a face (approximately 12 k bytes when optimally compressed), a fingerprint (10 k bytes) or an iris (30 k bytes). There is, however, a continuing need for improved security, to stay at least one step ahead of counterfeiters.

Background prior art may be found in the following documents:

US2003/134105, which describes a volume hologram multilayer structure, which is stuck over a photograph, which provides personal information although the hologram itself does not contain personal information; U.S. Pat. No. 5,396,559, which describes the use of a dot pattern (as a form of sophisticated Moire fringe) recorded in a photograph or hologram rather, than recording a biometric image; U.S. Pat. No. 4,563,024, which describes use of a photograph which identifies the owner or user of a device rather than: a hologram storing a biometric image personal to a user of the identification device; EP 0 869 408A, which is similar to US2003/0134105 in that the personalised image in this device is a photograph and the hologram is merely used to protect this image; U.S. Pat. No. 5,986,746, which describes a fingerprint scanner using a hologram (but the hologram is not used for recording the fingerprint); GB 2313944A; EP 0010611A; U.S. Pat. No. 5,862,247; U.S. Pat. No. 5,815,598; U.S. Pat. No. 5,095,194; U.S. Pat. No. 3,704,949; U.S. Pat. No. 4,532,508; JP 63201795; JP 7096693A; DE197 13 218A.

Therefore the invention provides, in a first aspect, a data carrier comprising: a hologram storing data to reproduce an image of a portion of a human body characteristic of an individual; and a second data bearing device; and wherein data stored by said second data bearing device is verifiable using data stored in said hologram.

In this way embodiments of the data carrier link the biometric image stored in the hologram to other data stored on the card so that this other data is verifiable using a hologram. The verification maybe carried out using the holographically stored image itself or by employing additional information stored with the holographic image, for example in a different viewing plane. Thus the data stored by the second data-bearing device may comprise first data for verifying with the image—using either one of the first data and the reproduced image to verify the other—and second data which is in turn verified by this verification process.

Additionally or alternatively the hologram may store additional data such as a code, for example an alphanumeric code or a bar code. The data stored by the second data-bearing device may comprise third data for verification with this additional data (either one verifying the other) and fourth data verified by this verification process. The aforementioned second and fourth data may comprise the same data to, in effect, provide a double- or cross-check—for example the holographic image may be employed to verify data stored by the second data bearing device and, in turn, data stored within this device may be used to verify, say, a code stored within the hologram.

The hologram may store the image in a first view and the additional data in a second view, for example these views comprising different planes of a reproduced holographic image, preferably such that the image and the additional data are separable by a viewing system. Optionally a third view or image plane may store further additional data within the holograph such as, for example, an identifier for a machine which was used to record or fabricate a hologram.

Optionally the additional data and/or further additional data, that is views other than the reproduced image view, may be recorded at a separate viewing or reconstruction angle or wavelength (for example in the ultraviolet or infrared) such that reproduction at a wavelength visible to the human eye is inhibited.

Preferably the hologram comprises a reflection or volume hologram. Preferably the image comprises a substantially two-dimensional image to facilitate verification and, where employed, the storage of additional data. The second data bearing device may comprise an integrated circuit memory device such as a smart card chip, and is preferably tamper-resistant. However in other arrangements the second data bearing device may comprise a substrate bearing graphics, preferably machine-readable graphics, and in such an arrangement the hologram is preferably attached to the substrate in such a way that it is difficult to remove without destroying the hologram (to inhibit attaching the hologram to a substrate with counterfeit data).

One way of linking data in the hologram and in the chip is simply to store an electronic or soft copy of the hologram on the chip. This is facilitated by recording a hologram of an electronically reproduced biometric image which is substantially planar. This facilitates storage of a two-dimensional rather than three-dimensional image on the chip, occupying less storage space, and also speeds up comparison of the holographic and electronically stored images. Preferably, in such an arrangement, the stored image is substantially the same as the original image used to create the hologram, further facilitating comparison of the two images.

In another arrangement a key is embedded in the hologram as additional data (in addition to the image) and data stored on the chip is encrypted with this key. This key may comprise, for example, a key of a public key infrastructure (PKI) technology. This then links the holographic image (which, because it is a biometric image, may be used for identification purposes) to the data stored on the chip (because, for example, it is difficult to re-write just part of the data stored on a chip when encrypted or signed in this way).

In a related aspect the invention provides a method of verifying data stored on a data carrier, the data carrier comprising a hologram storing data to reproduce an image of a portion of a human body characteristic of an individual; and a second data bearing device; and wherein data stored by said second data bearing device is verifiable using data stored in said hologram, the method comprising: reproducing said characteristic image: comparing said reproduced image with a view of an individual to verify data stored in said hologram; verifying, responsive to a result of said comparison, data stored by said second data bearing device using data stored in said hologram.

The verifying is preferably performed automatically, by machine, and may comprise comparing and/or decrypting, and may employ the stored image data or additional data stored in the hologram in association with the image data. The method provides improved data verification because, among other reasons, holograms are difficult to copy or reproduce. This is especially true of volume holograms, in particular when, as contemplated, these holograms are in the form of reflection holograms containing images which reconstruct in specific colours, and more particularly in a plurality of specific colours. Such a plurality of specific colours, when reconstructing a spatially integrated multi-colour hologram, may produce images which approximate the true colour of a real object (such as a human face). The selection of these specific colour components can be made in accordance with a desire to balance a level of perceived realism of the reconstructed image with a desire to present technical difficulty to a counterfeiter, who may attempt to contact copy a hologram with laser light as a means of duplication of, say, a label. Thus the recording apparatus and the verifying apparatus described herein may each comprise means for recording and/or verifying multicolour holograms.

The use of colour in a hologram may not necessarily be used to impart realistic colour to a reconstructed image, but instead component colours may be chosen to produce unrealistic or abstract colour in an image for the purpose of ease of identification by machine or eye. An example is the construction of a fingerprint whose tonal contrast is substituted for colour contrast, so that for example, in an original image graphic configuration, the high tones (eg. high brightness or contrast) are substituted red and the low tones (eg. low brightness or contrast) are substituted blue. Such an image can be both eye-catching and advantageous in security terms since it presents a complex twin verification target for the machine read system, in addition to an unusual, spectacular and easily-identified subject for the visual observer. Here, the references to and use of the term multi-colour may include wavelengths which are invisible or partially visible to the human eye, such that an image has an appearance which differs between its subjective visual appearance and its perception by machine read equipment.

The comparison of the reproduced image from the hologram with the view of an individual may be performed visually but may also be performed by machine, for example automatically capturing image data of the view and comparing this with an electronically captured image of the reproduced image read from the hologram. Further, additional verification may also be introduced by comparison with a new live scan of the bearer's biometric at an entry port.

In a simpler arrangement an image from the hologram, say of a fingerprint, and an electronically captured image of the fingerprint of the individual may be compared by eye, although preferably in this example conventional methods of fingerprint comparison are employed such as the co-incident sequence method (a standard technique employed by police forces for many decades). A second view of the hologram, preferably separable from the first image by the viewing system, contains a code derived from the fingerprint image and, optionally, from personal details of the relevant individual. This code may also be stored as graphics on the card and/or on a magnetic strip and/or in a chip.

In a further aspect the invention provides apparatus for capturing and recording a biometric image as a hologram for a data carrier, the apparatus comprising: a biometric image capture device; means for electronically reproducing said captured image as a reproduced image; and means for recording said reproduced image in a holographic recording material for developing into a hologram.

Electronically reproducing the captured image provides control over the image and facilitates subsequent verification operations as described above. In preferred embodiments the electronically reproduced image is substantially planar. The apparatus may also include means to write additional data, such as a code, into the hologram; this additional data may be captured, for example, at a user input terminal or downloaded from a database over a network. In some preferred arrangements the apparatus also includes means for storing the captured image in a data store for comparison with the recorded image. The data store may comprise a remote data store, accessed, for example, when data is written into a chip for creating a data carrier, or data may be written directly into a chip on a card or other substrate. Preferably this chip is then kept securely in association with the hologram until the hologram has been chemically or physically processed or developed to render it substantially permanent.

In a further aspect the invention provides apparatus for capturing and recording a biometric image comprising a biometric image capture device, a spatial light modulator to reproduce a substantially two-dimensional version of the captured image, and a holographic writer to write the reproduced image into a hologram. Preferably the image is written as a reflection hologram. Alternatively, the image may be recorded as a volume transmission hologram although transmission holograms are not colour selective in their reconstruction and have a slightly lower inherent security value. Preferably the spatial light modulator is in close proximity to or adjacent the holographic recording medium; preferably a diffuser is employed in the object (or reference) beam to create a hologram with a diffused or speckled appearance rather than a hologram with a specular appearance.

In a further aspect the invention provides a method for creating a data carrier incorporating a hologram and a second data bearing device, the method comprising capturing biometric information and using this to create a preferably substantially planar image displaced from the film surface; recording the image into a hologram; and recording data derived from or verifiable using data stored in the hologram on a semi-conductor memory device. Thus preferably the memory device stores a version of the image, for example a compressed version of the image, and preferably the memory device also stores cryptographic data which is also written into the hologram. Preferably the data is stored as a reflection hologram. Preferably the memory device and hologram are bonded to a common substrate or otherwise encapsulated in an identity document or identifying card. Preferably the exposed hologram is chemically processed separately, preferably in a secure location. Preferably the data stored in the semiconductor memory is also stored in a database for later use, for example for verification purposes. Preferably a record is also kept of the holograms recorded, either as a list or as a set of images (or as both).

The invention further provides processor control code, in particular on a data carrier such as memory, a disk or an optical or electrical signal carrier, to implement the above described method.

Further aspects of embodiments of a system and data carrier for the capture and recording of a biometric image, in particular a fingerprint, as a hologram for use with a document such as an identity card are described below.

The biometric, in particular fingerprint, image is preferably captured by a reader and reproduced on a substantially planar spatial light modulator (LCD display) for recording as a hologram. This solves a number of problems with the arrangements described in the prior art and, in particular, provides a substantially planar holographic image, which simplifies image comparison and recognition. This further provides advantages such as enhanced viewing angle, as well as facilitating the use of other recording techniques as described below (e.g. mechanical contact with film). Furthermore this allows the image of the fingerprint to be positioned in a plane such that only a camera correctly focused onto the plane will see a correctly focused image from the hologram. Further by recording an image in a discrete plane the options of using additional, for example, substantially parallel planes to record additional information, such as bibliographic and other details, is made available.

The holographic image is recorded as a volume, reflection hologram in which, roughly speaking, the fringes are in planes substantially parallel in at least one plane to the surface of the hologram rather than substantially perpendicular to the surface. Volume holograms have special security advantages, and in particular they difficult to copy. Those skilled in the art of holography are able to arrange colour and configurational complexities which provide considerable difficulty to the counterfeiter attempting to simulate the appearance of the original hologram.

Any conventional holographic recording material may be employed but preferably the hologram is recorded in silver halide rather than photopolymer film, which facilitates rapid recording of a hologram and hence makes rapid creation of biometric holograms on a large scale practically feasible using bench-top apparatus including lasers of low power. This could, for example, be installed in secure locations such as, say, larger post offices. Furthermore the use of silver halide film with small silver particles enables the holograms to be fabricated so as to be substantially transparent, thus enabling a hologram to overlie other information on a document, for example, text. The overlaying of a transparent layer hologram onto a printed substrate adds difficulty to the task of contact copying the hologram for illicit duplication.

The recording apparatus preferably utilises a spatial light modulator (LCD display) which is preferably in mechanical contact with the holographic film (for example, separated by a small distance by means of a glass or quartz substantially index-matching spacer). This stabilises the mechanical arrangements for recording the image, again facilitating bench-top operation. One problem with the traditional means of recording a biometric hologram directly from a human subject is the need to record a stationary subject in order to create a recordable standing wave in the hologram. The use of pulse lasers or conventional photographic means to stabilise the subject for recording is avoided by the use, in embodiments of the present invention, of a combination of software and a spatial light modulator as described in more detail later.

The SLM (spatial light modulator) image may be substantially in contact with the film (giving a large, potentially up to 180°, viewing angle) or the image may be spaced away from the surface of the recording film by a distance of 0 to 1 cm (and less than the coherence length of the recording laser). This positions the holographic image a corresponding distance from the surface of the recorded holographic film enabling the advantages referred to above regarding image planes. By employing a small, controlled (or controllable) distance, the viewing angle may still be kept large. Conventional holography systems employing the use of a two-generation mastering regime are frequently limited to a relatively narrow angle of view. With holographic images of limited depth, a diode laser with only a short coherence length may then be employed, giving a cost saving.

The underside of the SLM may be provided with a diff-user (so that the illuminating laser illuminates the SLM through the diffuser, which is preferably adjacent the SLM) since this creates a preferred form of hologram. Such a hologram has a matt or transparent rather than shiny image having, under laser illumination, a speckle pattern characteristic of a genuine hologram.

Preferably the bench-top recording apparatus includes storage and/or network communication means for recording a “golden” image of the captured biometric image (fingerprint) which exactly corresponds to the image displayed by the SLM, again considerably simplifying rapid comparison of a recorded fingerprint hologram (or other biometric image) for identification purposes. Preferably this image is stored on the above described data carrier; it may be signed or encrypted, for example verifiable and/or readable using a key embedded in the hologram. Because the hologram records not the biometric image per se but rather a captured and re-displayed electronic representation of the biometric image the golden image can, in effect, be an exact copy of the recorded hologram thus facilitating, say, a pixel-by-pixel comparison of a holographically recorded image with a stored image rather than having to rely on much slower, more costly and computationally expensive image processing techniques for biometric image (e.g. finger or face) recognition, which in general are still not well developed.

These and other aspects of the invention will now be further described, by way of example only, with reference to the accompanying figures in which:

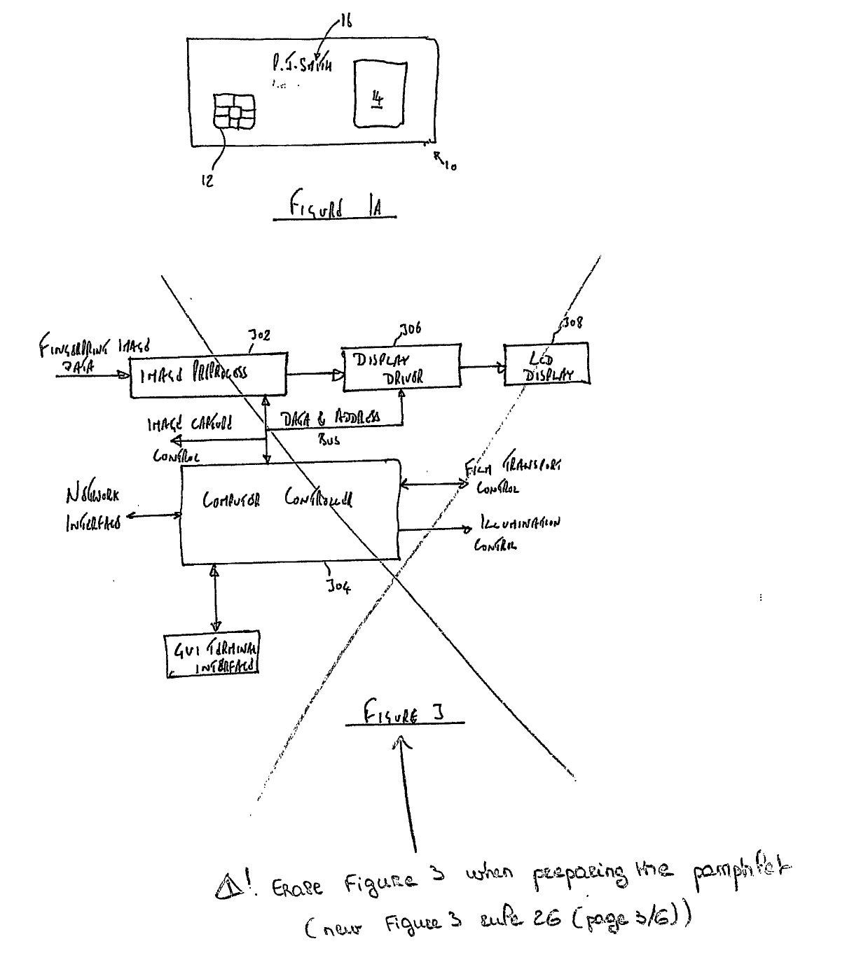

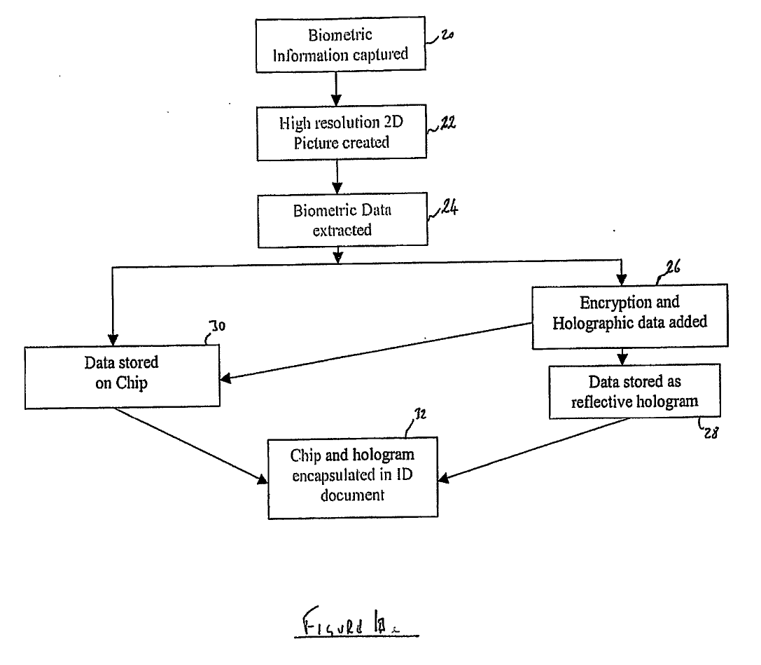

FIGS. 1a and 1b show, respectively, a data carrier incorporating a biometric hologram according to an embodiment of the present invention, and a flow diagram for the fabrication of the data carrier of FIG. 1a;

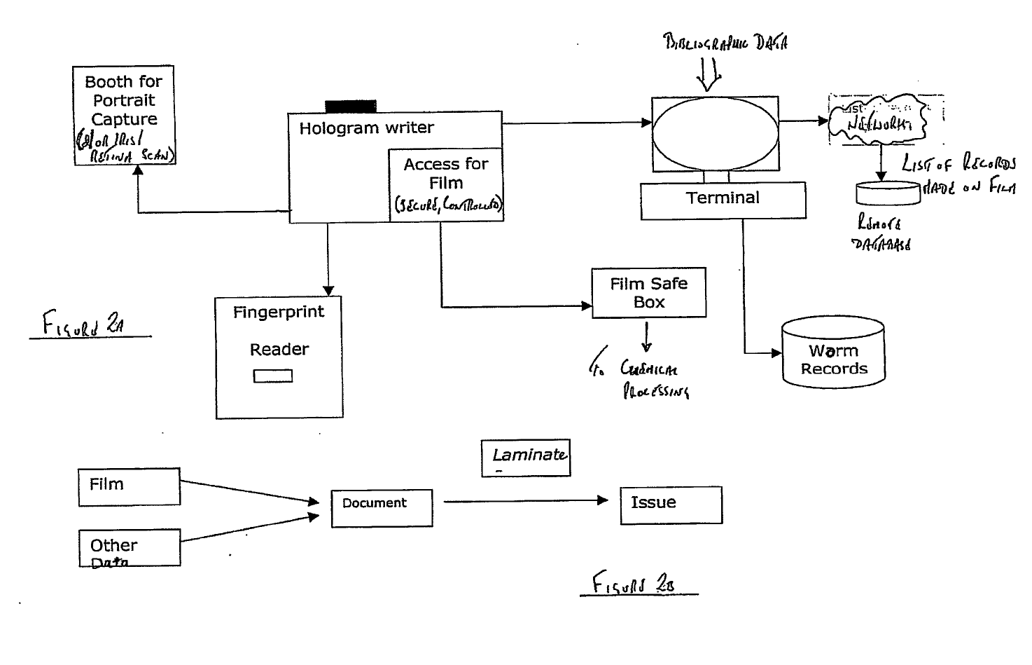

FIGS. 2a and 2b show, respectively, a biometric hologram writer, and a data carrier fabrication process;

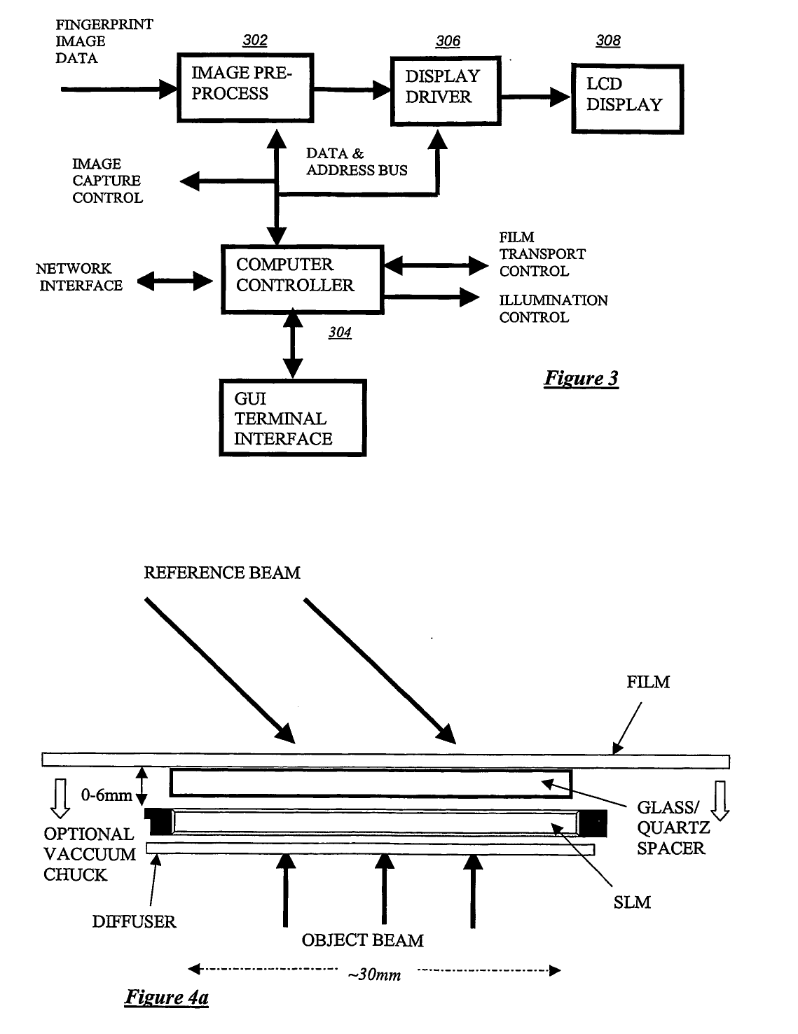

FIG. 3 shows a computer control system for the apparatus of FIG. 2a;

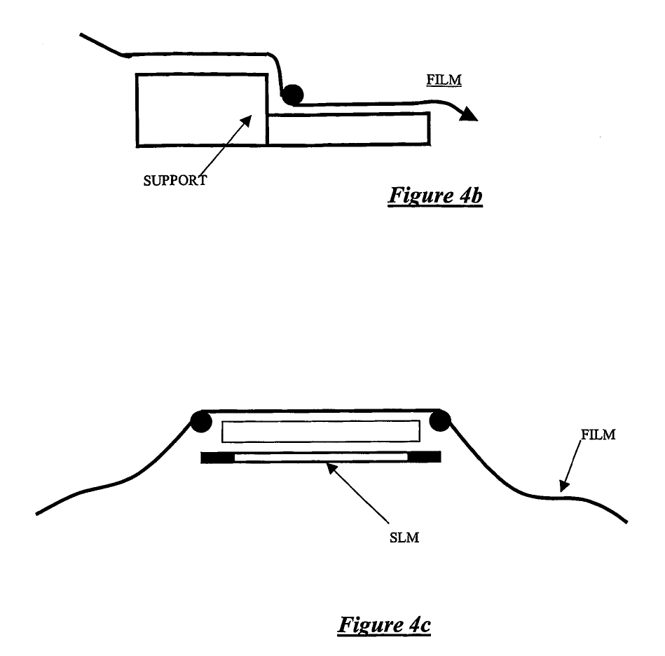

FIGS. 4a to 4c show details of a holographic writer mid first and second alternative holographic film supports; and

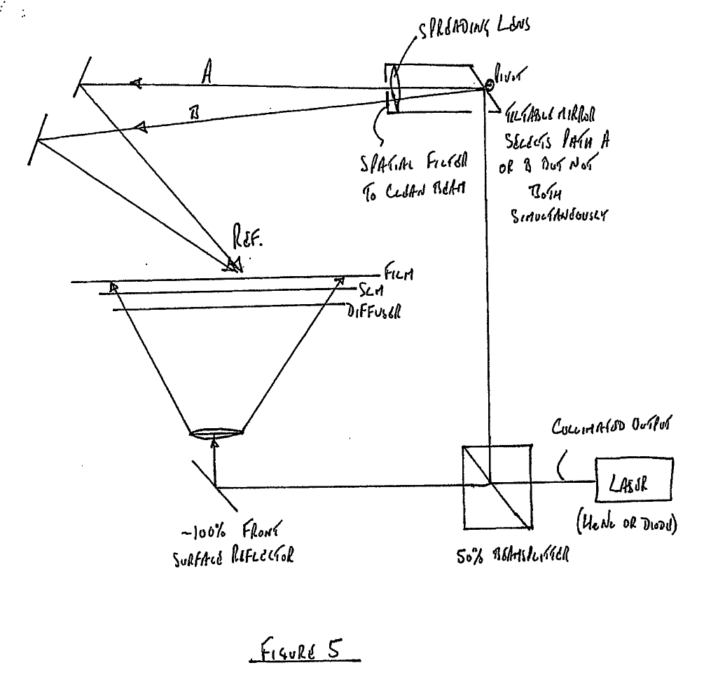

FIG. 5 shows a schematic diagram of an optical arrangement for the apparatus of FIG. 2b;

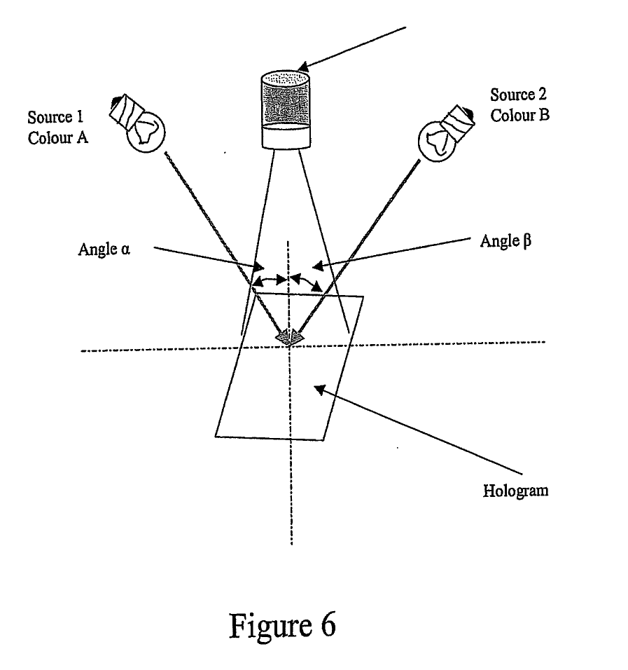

FIG. 6 shows a machine interrogation device for a holographic data carrier.

Referring to FIG. 1a, a data carrier 10 comprises an integrated circuit memory chip 12, either having contacts (as shown) or for contact-less communication with a reader. The data carrier 10 also includes a hologram 14 storing biometric and other data and text 16 such as a name, address, national security number and the like. Data carrier 10 may be based upon a so-called smartcard and may comprise an identity card or document, driving license, passport, credit card or any other form of identification.

Referring to FIG. 1b card 10 is created by capturing biometric information such as a fingerprint (step 20) and creating a high resolution two dimensional image from this (step 22). Where necessary relevant biometric data is extracted (step 24) for storage on the chip 12. In the case of a fingerprint, for example, data stored may comprise five-zone coincidence sequences, eight or nine coincidences generally being taken as sufficient for a match. Optionally other data may be created or input for storage with the hologram. At step 26 cryptographic data is created, for example a key, and this is combined with the biometric image and presented for storage as a reflective or reflection hologram (step 28); the biometric data or image together with any additional data, preferably encrypted with the key or another key of a pair to which the key belongs is stored on the integrated circuit memory device 12 (step 30). The chip and hologram are then encapsulated in all identity document (step 32).

FIG. 2a shows a holographic recording system. Data for recording with the hologram may be entered into the terminal (which may also create or download random numbers for keys), and write once read many (WORM) records are created locally and also, via a network, at a remote database. The local and/or remote records may also include a ‘golden’ image corresponding to a captured image as reproduced by an electronic reproduction system for recordal as a hologram.

The film is held securely within the hologram writer, for example accessed by a mechanical key, and a secure film box can be removed from the writer and sent securely for chemical processing. A typical process for incorporating the developed holographic film and other data (ie the semi conductor chip) into a document is outlined in FIG. 2b.

Referring next to FIG. 3, this shows a block diagram of a computer control system for the apparatus of FIG. 2a. Biometric data such as a fingerprint image is captured by commercial off the shelf equipment such as the BAC Securetouch USB2000 available from Bannerbridge plc of Basildon, UK and provided to an image pre-processor 302 which, under control of a control processor 304, provides an image to display driver 306 for display on an LCD display 308, for example at SVGA resolution, at a size of approximately 30 mm². The size and resolution of the display may be determined based upon processing power and cost. The LCD display acts as a spatial light modulator as described below with reference to FIG. 4a and thus preferably allows illumination through the device. Typically such a display comprises a micrometer thick sheet of polarising material followed by electrically configurable liquid crystal material. The LCD display may be of a type which has permanently on or off pixels rather than pixels which are refreshed, for example a ferroelectric liquid crystal device so that the pixels stay in either an on or an off (black or white) state for the duration of die image recordal, typically around two seconds. Alternatively a conventional, raster scanned display may be employed, thus facilitating recordal of grey levels, useful, for example, for representing faces. It will be appreciated that the recorded biometric image is a monochrome image and, where necessary, a captured input image is converted into a monochrome image by preprocessor 302. A suitable LCD display is available from Central Research Laboratories Ltd of London, UK, for example model SVGA2 monochrome transmission LCD. An LCD display without an in-built polariser may be employed with plane polarised laser illumination, which in effect provides approximately 50% more light.

In some embodiments a colour LCD panel may be used in order to incorporate colour imagery into the hologram in the case where a plurality of laser sources are incorporated in the exposure device. A colour TFT (thin film transistor) panel of the type produced by Sharp Industries is suitable, since the TFT type of system is capable of the desired high contrast ratio.

Other means of creating colour in the hologram reconstruction are feasible but less preferred. For example chemical or physical expansion of the film layer prior to exposure is a means by which ‘pseudo-colour’ effects may be incorporated into the holographic image. The adjustment of the final thickness of the hologram layer during chemical processing of the film is, however, a preferred means to control the colours of the reconstructed hologram, and the developer and bleaching solution for silver halide materials may be designed/selected to produce the desired colours in the final image. The layer properties of the selected recording film also affect the colour reconstruction of the final image.

Referring next to FIG. 4a this shows the optical configuration of the spatial light modulator and film. The spatial light modulator may be substantially adjacent the film or may be spaced apart from the film by a glass or quartz spacer. Spacers of 2, 4 or 6 mm may be employed, optionally mechanically selectable on the control of the computer controller 304 in order to record images at different planes within the hologram. The maximum adjustment of the spacing between the spatial light modulator and film is determined by the coherence length of the laser, and is typically a few mm to a few cm (say in the range 1 mm to 30 mm, possibly up to 100 mm) for a diode laser (since, as shown later in FIG. 5, optical path lengths from the laser for the object and reference beams are preferably substantially matched).

Preferably the arrangement includes a diffuser prior to the spatial light modulator comprising, for example, ground glass or substantially non-birefringent plastic material such as polycarbonate or polyester film. Such diffusers are available from Lee Filters in the UK. The diffuser does not destroy the hologram since the differences in optical path lengths to the film from diffused rays originating from a point on the diffuser is very small, but the diffuser has the effect of providing a hologram with a speckle pattern rather than a so-called shadowgram which appears shiny lice a mirror.

Many mechanical schemes may be employed for holding the film in close proximity to the spatial light modulator or spacer depending, for example, on whether sheet fed or roll fed film is employed. FIGS. 4b and 4c show two examples of film transport mechanisms; for sheet film a sheet feeder may be employed; optionally a vacuum chuck may also be used to ensure the holographic recording material bears against the spatial light modulator or spacer. In a less preferred arrangement a mounting frame holds the SLM and/or spacer in a fixed or controllable spatial relationship with respect to the film. In any of the above arrangements index matching or interface coupling temporary adhesive may be employed if necessary.

FIG. 5 shows one example of an optical configuration for the apparatus of FIG. 2a. In particular this optical configuration shows how the reference beam may be tilted between two alternative positions in order to record two sets of data within the holographic film, for example viewable at different wavelengths or in different planes, or in the same plane (with reference to the plane of the recording material) of the generated holographic image.

In order to enhance the effectiveness of the image analysis for the purpose of verification or comparison with other data, the preferred method of examination of the data is via a machine interrogation device. This device, shown in FIG. 6, comprises illuminating sources whose light is delivered at specific angles to the surface of the hologram device under examination. The label is placed into the reader perpendicular and centrally such that its surface, and thus its holographic image planes, are correctly distanced from a camera with a shallow depth of field focussed in the plane of the image. Adjustment of the focal plane is possible by electronic or mechanical means. The illumination sources are preferably narrow-band LED or filtered white lamps such that their angle of incidence is finely adjusted for compatibility with the hologram exposure device, and their colour may be compatible with the reconstruction colours of the genuine hologram it is intended to verify. Thus unauthorised attempts to produce a hologram to satisfy these stringent conditions of view are unlikely to succeed.

We have described above a data carrier comprising a hologram storing data to reproduce an image of a portion of a human body characteristic of an individual, and a second data bearing device, for example an integrated circuit memory device such as a smart card chip. The data stored by said second data bearing device is verifiable using data stored in the hologram and in this way the data carrier links the biometric image stored in the hologram to other data stored on the card so that this other data is verifiable using the hologram.

In a variation of this system the hologram with biometric information is replaced by a hologram bearing some other graphic, image or logo, such as a graphic of a product. The second data bearing device may then comprise a unique element such as a bar code and/or microtext; the carrier itself may comprise a plastic (eg. polyester-based) card. In this way each data carrier can be made individual and unique, different to all the rest. Preferably the holographic image is not on the surface of the data carrier but spaced away from the surface. For this embodiment a volume hologram or a surface relief type hologram may be employed, for example fabricated from photothermoplastic or a photopolymer.

The verification may be carried out using the stored image itself or by employing additional information stored with the holographic image, for example in a different viewing plane. The data stored by the integrated circuit memory device preferably therefore includes first data for verifying with the image (using either one of the first data and the reproduced image to verify the other) and second data which is in turn verified by this verification process.

Recording a hologram of an electronically reproduced biometric image which is substantially planar facilitates storage of a two-dimensional rather than three-dimensional image on the chip, occupying less storage space, and also speeds up comparison of the holographic and electronically stored images. Preferably, in such an arrangement, the stored image is the same as the original image used to create the hologram, further facilitating rapid comparison of the two images.

In an alternative arrangement there is contemplated a key embedded in the hologram in addition to the image, data stored on the chip being encrypted with this key. This key may comprise, for example, a key of a public key infrastructure (PKI) technology. This then links the holographic image (which, because it is a biometric image, may be used for identification purposes) to the data stored on the chip (because, for example, it is difficult to re-write just part of the data stored on a chip when encrypted or signed in this way).

We have also described a method of verifying data stored on a data carrier, the data carrier comprising a hologram storing data to reproduce an image of a portion of a human body characteristic of an individual, and a second data bearing device, for example a “chip”. The data stored by the chip is verifiable using data stored in the hologram. The method comprises reproducing the characteristic image, comparing the reproduced image with a view of an individual to verify data stored in said hologram, and verifying, responsive to a result of the comparison, data stored by the chip using the data stored in the hologram.

The comparing verifying is preferably performed automatically, for example by automatically capturing image data of the view of the individual and comparing this with an electronically captured image of the reproduced image read from the hologram. The method provides improved data verification because, among other reasons, holograms are difficult to copy or reproduce; this is especially true of volume holograms. For a fingerprint image a second view of the hologram, separable from die first image (for example because it is in a different plane) may contain a code derived from the fingerprint image and, optionally, from personal details of the relevant individual. This code may also be stored as graphics on the card and/or on a magnetic strip and/or in a chip.

The above verification method may be adapted for verifying data carrier carrying a graphic of a product and a unique element such as a bar code and/or microtext, by identifying the reproduced image (for example by comparison with a set of possible images) and then verifying the unique data (alternatively this method may be performed in “reverse”, verifying the unique data first and then checking the holographically reproduced image).

We have further described apparatus for capturing and recording a biometric image as a hologram for a data carrier, the apparatus comprising: a biometric image capture device; means for electronically reproducing said captured image as a reproduced image; and means for recording said reproduced image in a holographic recording material for developing into a hologram.

In some preferred arrangements the apparatus also includes means for storing the captured image in a data store for comparison with the recorded image. The data store may comprise a remote data store, accessed, for example, when data is written into a chip for creating a data carrier, or data may be written directly into a chip on a card or other substrate. Preferably this chip is then kept securely in association with the hologram until the hologram has been chemically processed or developed to render it substantially permanent.

We have further described apparatus for capturing and recording a biometric image comprising a biometric image capture device, a spatial light modulator to reproduce a substantially two-dimensional version of the captured image, and a holographic writer to write the reproduced image into a hologram The spatial light modulator (SLM) may comprise a liquid crystal device, a digital multimirror device (DMD, from Texas Instruments, Inc) or some other type of SLM.

Preferably the image is written as a reflection hologram and the spatial light modulator is in close proximity to or adjacent the holographic recording medium. A diffuser may be employed in the object (or reference) beam to create a hologram with a diff-used or speckled appearance rather than a hologram with a specular appearance.

We have further described a method for creating a data carrier incorporating a hologram and a second data beaming device, the method comprising capturing biometric information and using this to create a (preferably substantially two-dimensional) image; recording the image into a hologram; and recording data derived from or verifiable using data stored in the hologram on a semi-conductor memory device. Thus preferably the memory device stores a version of the image, for example a compressed version of the image, and preferably the memory device also stores cryptographic data which is also written into the hologram. Preferably the data is stored as a reflective hologram, and the memory device and hologram are bonded to a common substrate or otherwise encapsulated in an identity document or identifying card.

No doubt many other effective alternatives will occur to the skilled person and it will be understood that the invention is not limited to the described embodiments but encompasses modifications apparent to those skilled in the art within the spirit and scope of the claims appended hereto.

1-37. (canceled)

38. A data carrier comprising:
a hologram storing data to reproduce an image of a portion of a human body characteristic of an individual; and
a second data bearing device; and
wherein data stored by said second data bearing device is verifiable using data stored in said hologram.

39. A data carrier as claimed in claim 38 wherein said data stored by said second data bearing device comprises first and second data, said first data being for verification of one of said first data and said image with the other, and second data being verified by said verification.

40. A data carrier as claimed in claim 38 wherein said hologram stores additional data, and wherein said data stored by said second data bearing device comprises third and fourth data, said third data being for verification of one of said additional data and said third data with the other, and fourth data being verified by said verification.

41. A data carrier as claimed in claim 38 wherein said image comprises a substantially two-dimensional image.

42. A data carrier as claimed in claim 38 wherein said hologram comprises a volume reflection hologram.

43. A data carrier as claimed in claim 38 wherein said second data bearing device comprises an integrated circuit memory device.

44. A method of verifying data stored on a data carrier, the data carrier comprising
a hologram storing data to reproduce an image of a portion of a human body characteristic of an individual; and
a second data bearing device; and
wherein data stored by said second data bearing device is verifiable using data stored in said hologram, the method comprising:
reproducing said characteristic image;
comparing said reproduced image with a view of an individual to verify data stored In said hologram;
verifying, responsive to a result of said comparison, data stored by said second data bearing device using data stored in said hologram.

45. Apparatus for capturing and recording an image such as a biometric image as a hologram for a data carrier, the apparatus comprising:
a biometric image capture device;
means for electronically reproducing said captured image as a reproduced image; and
means for recording said reproduced image in a holographic recording material for developing into a hologram.

46. Apparatus as claimed in claim 45 wherein said reproduced image is substantially planar.

47. Apparatus as claimed in claim 46 comprising means to record for said hologram a first view comprising said reproduced image and a second view comprising additional data.

48. Apparatus as claimed in claim 46 wherein said hologram comprises a volume reflection hologram or volume transmission hologram.

49. Apparatus as claimed in claim 45 further comprising means for storing said captured image in a data store for comparison with said recorded image.

50. A data carrier comprising:
a hologram storing data to reproduce an image of a graphic associated with a product; and
a second data bearing device storing data unique to the data carrier.

51. A data carrier as claimed In claim 50 wherein said data carrier is substantially planar and wherein said graphic image is spaced away from the plane of said data carrier.

52. A data carrier as claimed in claim 50 wherein said second data bearing device comprises a unique, machine-readable code.

53. A data carrier as claimed in claim 50 wherein said data carrier is substantially planar and wherein said second data bearing device defines an image spaced away from the plane of said data carrier and comprising said unique data.

54. Recording apparatus for recording a hologram for a data carrier, the apparatus comprising a spatial light modulator (SLM) in mechanical contact with a holographic recording medium.

55. Recording apparatus for recording a hologram for a data carrier, the apparatus comprising a spatial light modulator (SLM), a holographic recording medium, and an optically transparent spacer between the holographic recording medium and the SLM.

56. Recording apparatus as claimed in claim 55 wherein said spacer has a thickness of less than 3 cm, preferably less than 1 cm.

57. Recording apparatus as claimed in claim 55 further comprising a laser to record said hologram.

58. Recording apparatus as claimed in claim 57 wherein said spacer has a thickness less than a coherence length of said laser.

59. Recording apparatus as claimed in claim 57 further comprising a diffuser, and wherein said laser Is configured to illuminate said SLM through said diffuser.

60. Apparatus for capturing and recording an image, the apparatus comprising:
an image capture device;
a spatial light modulator to reproduce a substantially two-dimensional version of the captured image; and
a holographic writer to write the reproduced image into a hologram.

61. Apparatus as claimed in claim 60 wherein said image is written as a reflection hologram.

62. Apparatus as claimed in claim 60 wherein said spatial light modulator is in close proximity to or adjacent said holographic recording medium.

63. Apparatus as claimed in claim 60 further comprising a diffuser in an objector reference beam of said holographic writer to create a hologram with a diffused or speckled appearance.

64. A method for creating a data carrier incorporating a hologram and a second data bearing device, the method comprising:
capturing biometric information and using this to create an image;
recording the image into a hologram; and
recording data derived from or verifiable using data stored in the hologram on said second data bearing device.

65. A method as claimed in claim 64 wherein said image is substantially two-dimensional.

66. A method as claimed in claim 64 wherein said second data bearing device comprises a semi-conductor memory device.

67. A method as claimed in claim 64 wherein said memory device stores a version of the image and cryptographic data which is also written into the hologram.

68. A method as claimed in claim 64 wherein said data is stored as a reflective hologram.

69. A method as claimed in claim 66 wherein said memory device and said hologram are bonded to a common substrate or encapsulated in a single document or card.

70. A data carrier carrying processor control code to implement the method of claim 64.

71. Apparatus for verifying data stored on a data carrier, the data carrier comprising a hologram storing data to reproduce an image of a portion of a human body characteristic of an individual and a second data bearing device, and wherein data stored by said second data bearing device is verifiable using data stored in said hologram, the apparatus comprising:
means to reproduce said characteristic image;
means to compare said reproduced image with a view of an individual to verify data stored in said hologram;
means to verify, responsive to a result of said comparison, data stored by said second data bearing device using data stored In said hologram.

72. Apparatus for reading a data carrier carrying a hologram, the apparatus comprising:
at least one light source for illuminating the hologram, said at least one light source being configured to deliver light at a specific angle to the surface of said hologram to reconstruct a holographic image in an image plane spaced away from a plane of said data carrier; and
an imaging device focused in the plane of said holographic image, said imaging device having a sufficiently small depth of field as to substantially visually separate said plane of said holographic image from said plane of said data carrier.

73. A data carrier as claimed in claim 38 wherein said hologram is configured to reconstruct in a plurality of component colors.

74. A data carrier as claimed in claim 73 wherein said plurality of component colors comprise false colors configured to aid identification.

75. A data carrier as claimed in claim 73 wherein at least one of said component colors is substantially invisible to the human eye.
